(19) United States
(12) Patent Application Publication
(10) Pub. No.: US 2024/0362089 A1
(43) Pub. Date: Oct. 31, 2024

(54) SYSTEM AND METHOD FOR MANAGING EVENTS IMPACTING OPERATION OF DATA PROCESSING SYSTEMS USING A DIGITAL TWIN

(71) Applicant: Dell Products L.P., Round Rock, TX (US)

(72) Inventors: OFIR EZRIELEV, Be'er Sheva (IL); TOMER KUSHNIR, Omer (IL); MAXIM BALIN, Gan-Yavne (IL)

(21) Appl. No.: 18/309,171

(22) Filed: Apr. 28, 2023

(51) Int. Cl. G06F 9/54; G06F 11/34

(52) U.S. Cl. CPC G06F 9/542; G06F 11/3409

(57) ABSTRACT

Methods and systems for managing operation of data processing systems with limited access to an uplink pathway are disclosed. To manage the operation, a system may include a data processing system manager, a data collector, and one or more data processing systems. As the data processing system may not be able to transmit data to the data processing system manager, the data collector may provide observational data related to the operation of the data processing system to the data processing system manager. The data processing system manager may utilize a digital twin to simulate the operation of the data processing system and identify potential future occurrences of events that may impact the operation of the data processing system. The data processing system manager may identify instructions to remediate or avoid the future occurrences of the events and may provide the instructions as commands to the data processing system.

### FIELD

Embodiments disclosed herein relate generally to managing events impacting operation of data processing systems throughout a distributed environment. More particularly, embodiments disclosed herein relate to systems and methods for mitigating impact of events occurring during operation of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a block diagram illustrating a data processing system manager interacting with a data processing system and a data collector in accordance with an embodiment.

FIG. 3 shows a flow diagram illustrating a method of managing operation of a data processing system with limited access to an uplink pathway in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing operation of data processing systems with limited access to an uplink communication pathway. Data processing systems throughout a distributed environment may be positioned in remote locations and, to conserve computing resources and communication system bandwidth, may consume limited computing resources during operation and/or may have limited (or no) access to an uplink pathway (e.g., a communication system pathway allowing data transmissions from the data processing system to other entities in the system).

The data processing system may be responsible for facilitating computer-implemented services provided by the system. During operation, the data processing system may encounter events that may impact the operation of the data processing system (e.g., depart from nominal performance of the data processing system). Due to the limited computing resources available to perform computations, the data processing system may not be capable of identifying potential actions to mitigate the impact of the events. In addition, the lack of access to the uplink pathway may make it infeasible and/or impossible for the data processing system to query another entity for assistance.

To mitigate the impact of events (and/or prevent events) causing non-nominal operation of the data processing system while conserving computing resources and network bandwidth, the system may include a data processing system manager. The data processing system manager may obtain observational data from a data collector positioned remote to the data processing system via a pathway that is not the uplink pathway. The data collector may observe operation of the data processing system and the environment the data processing system is positioned in and may provide the observational data to the data processing system manager.

Without obtaining any data directly from the data processing system, the data processing system manager may host and operate a digital twin of the data processing system. Using the observational data, the digital twin may simulate operation of the data processing system under conditions representative of the environment in which the data processing system operates (e.g., via the conditions observed by the data collector). Analysis of the simulated operation may allow the data processing system manager to identify potential future occurrences of events that may impact the operation of the data processing system.

In response to the identified potential future occurrences of the events, actions intended to prevent and/or remediate the impact of the events may be identified. The data processing system manager may provide commands to the data processing system via a downlink pathway, the commands being intended to initiate performance of the actions by the data processing system when needed.

Thus, data processing systems with limited available computing resources and limited (or no) access to an uplink pathway may be provided with instructions to implement actions to alleviate an impact of a potential event on operation of the data processing system. By collecting data from a data collector positioned to observe the data processing system and simulating operation of the data processing system using a digital twin, the instructions may be generated without increasing computing resource and/or network bandwidth consumption by the data processing system.

In an embodiment, a method of managing operation of a data processing system with limited access to an uplink pathway by a data processing system manager is provided. The method may include: obtaining observational data for an environment in which the data processing system is located; simulating operation of the data processing system using the observational data and a digital twin, the digital twin being intended to duplicate operation of the data processing system in the environment; identifying, based on the simulated operation, a future occurrence of an event that is likely to occur and that will impact the operation of the data processing system; selecting a command for performance by the data processing system, the command being expected to mitigate an impact of the future occurrence of the event when performed by the data processing system; and providing the command to the data processing system to initiate performance of the command.

The uplink pathway may be used to obtain data from the data processing system and a downlink pathway may be used to transmit data to the data processing system.

The observational data may be obtained from a data collector, the data collector being located remote to the data processing system and being capable of transmitting the observational data via a different pathway from the uplink pathway.

Impacting the operation of the data processing system may include causing a departure from nominal operation of the data processing system.

Selecting the command may be performed via a process the data processing system does not have sufficient computing resources to perform.

Selecting the command may include: re-simulating the operation of the data processing system using the observational data, the digital twin, and the command; and identifying, based on the re-simulated operation, that the future occurrence of the event is unlikely to occur.

The command may be intended to be performed: prior to the future occurrence of the event, or concurrently with the future occurrence of the event.

The method may also include: identifying a similar data processing system, the similar data processing system being subject to conditions similar to those associated with the data processing system; and providing the command to the similar data processing system.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

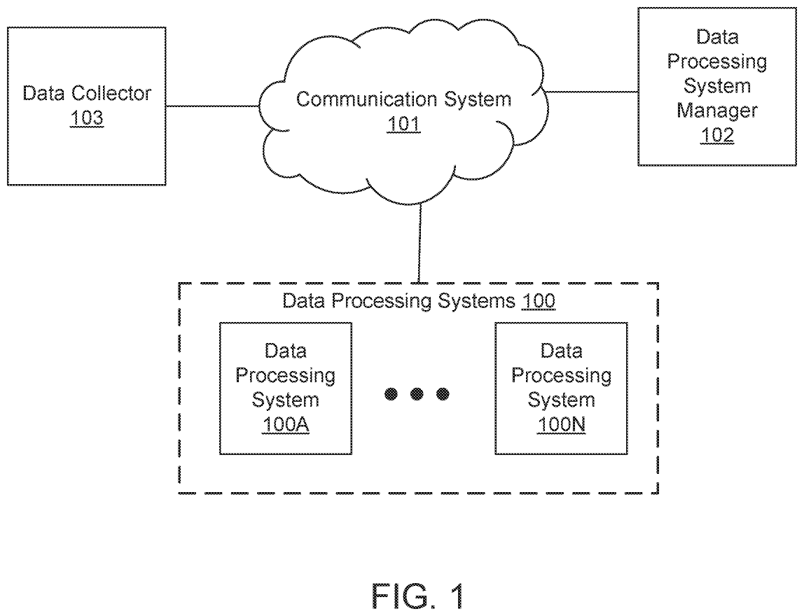

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include monitoring services (e.g., of locations), communication services, and/or any other type of computer-implemented services.

To provide the computer-implemented services, the system may include data processing system manager 102. Data processing system manager 102 may provide all, or a portion of, the computer-implemented services. For example, data processing system manager 102 may provide computer-implemented services to users of data processing system manager 102 and/or other computing devices operably connected to data processing system manager 102.

To facilitate performance of the computer-implemented services, the system may include one or more data processing systems 100. Data processing systems 100 may include any number of data processing systems (e.g., 100A-100N). For example, data processing systems 100 may include one data processing system (e.g., 100A) or multiple data processing systems (e.g., 100A-100N) that may independently and/or cooperatively facilitate the computer-implemented services.

All, or a portion, of data processing systems 100 may provide (and/or participate in and/or support the) computer-implemented services to various computing devices operably connected to data processing systems 100. Different data processing systems may provide similar and/or different computer-implemented services.

To facilitate performance of the computer-implemented services, the system may include data collector 103. Data collector 103 may include any number of data collectors (one data collector, multiple data collectors, etc.) that may provide (and/or participate in and/or support the) computer-implemented services to various computing devices operably connected to data collector 103.

When providing the computer-implemented services, the system of FIG. 1 may monitor events impacting operation of data processing systems throughout a distributed environment. Data processing systems 100 may be positioned in remote locations, may have limited computing resources available to run computations, and may have little (or no) access to an uplink communication pathway (through which to transmit data to data processing system manager 102, data collector 103, and/or any other entity).

However, a data processing system (e.g., data processing system 100A) may encounter an event that impacts the operation of the data processing system (e.g., by causing non-nominal operation). Due to the lack of computing capabilities, the data processing system may not be capable of learning how to remediate the impact of the event and/or prevent future occurrences of the event. In addition, the data processing system may be incapable of querying data processing system manager 102 (and/or any other entity) for a potential solution due to the lack of uplink pathway access.

In general, embodiments disclosed herein may provide methods, systems, and/or devices for mitigating an impact of an occurrence of an event during operation of data processing systems. To do so, the system of FIG. 1 may obtain observational data for an environment in which the data processing system is located. Operation of the data processing system may be simulated using the observational data and a digital twin of the data processing system. The simulated operation of the data processing system may reveal potential future occurrences of events that are likely to occur and may impact the operation of the data processing system.

In response to identifying the potential future occurrences of the events, the system of FIG. 1 may identify a command expected to mitigate an impact of the future occurrences of the event when performed by the data processing system and may provide the command to the data processing system via an available downlink pathway.

To provide the above noted functionality, the system of FIG. 1 may include data processing system manager 102. Data processing system manager 102 may: (i) obtain observational data for an environment in which the data processing system is located, (ii) simulate operation of the data processing system using the observational data and a digital twin, (iii) identify, based on the simulated operation, a future occurrence of an event that is likely to occur and that will impact the operation of the data processing system, (iv) select a command for performance by the data processing system, the command being expected to mitigate an impact of the future occurrence of the event when performed by the data processing system, and/or (v) providing the command to the data processing system to initiate performance of the command.

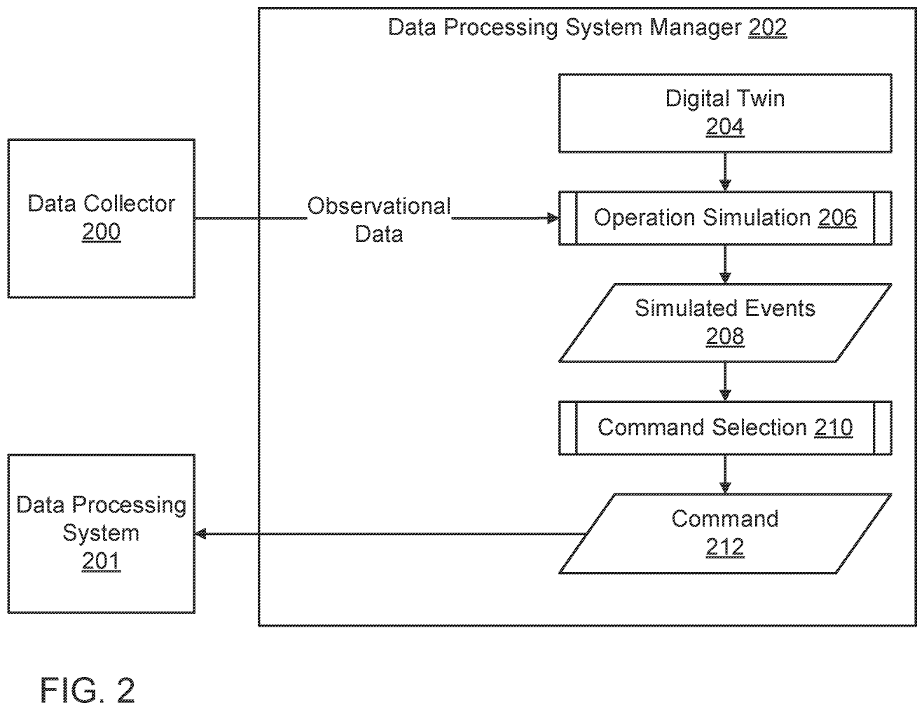

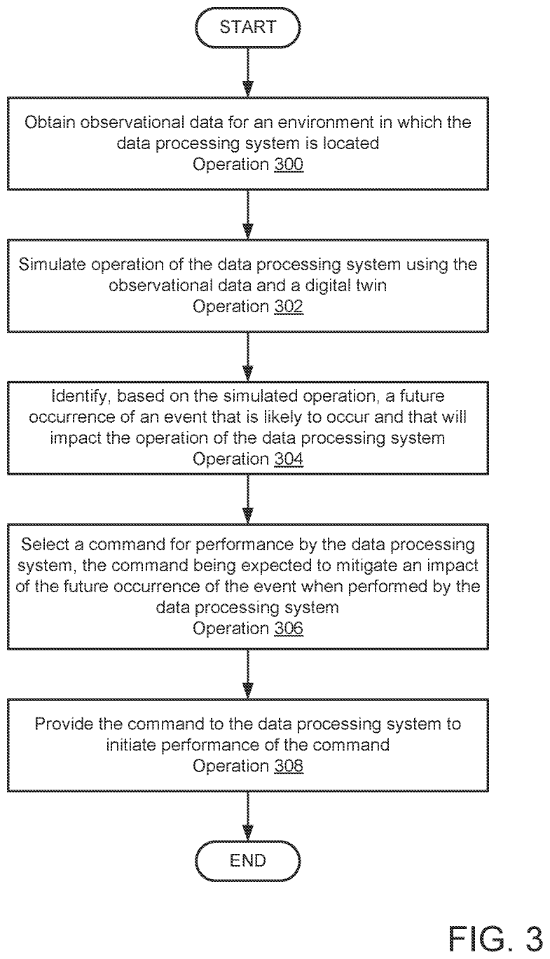

When performing its functionality, data processing system manager 102, data collector 103, and/or data processing systems 100 may perform all, or a portion, of the methods and/or actions shown in FIGS. 2-3.

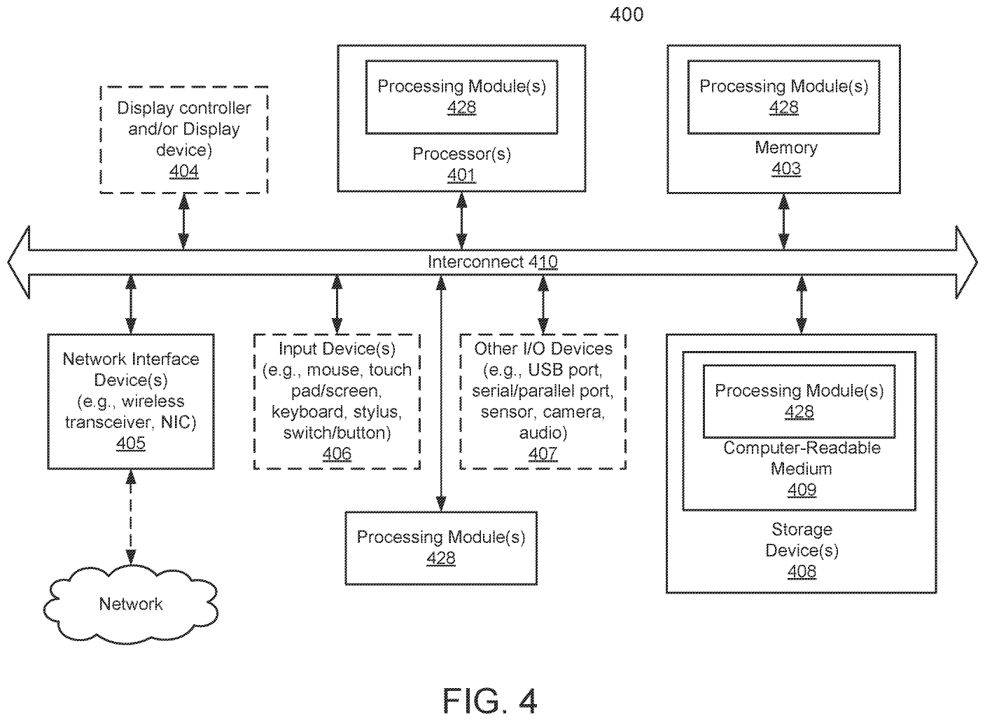

Data processing systems 100, data collector 103, and/or data processing system manager 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100, data collector 103, and/or data processing system manager 102 are implemented using an internet of things (IoT) device, which may include a computing device. The IoT device may operate in accordance with a communication model and/or management model known to data processing system manager 102, data collector 103, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

Communication system 101 may include any number of communication pathways (e.g., channels for transmissions to be sent and received), some of which may be accessible to different components of the system of FIG. 1. For example, communication system 101 may include an uplink pathway over which data may be transmitted from data processing systems 100 to data processing system manager 102. Use of the uplink pathway by data processing systems 100 may consume energy and network bandwidth and, therefore, may be undesirable. Data processing systems 100 may subsequently have little to no access to the uplink pathway. In addition, to reduce volume of data transmissions via the uplink pathway, various data reduction techniques (e.g., resulting in highly quantized data) may be implemented to improve efficiency of use of limited available uplink pathway bandwidth.

In contrast, a downlink pathway facilitating transmissions from data processing system manager 102 to data processing systems 100 may be available due to the increased computing capabilities and/or energy capabilities of data processing system manager 102. Any number of additional pathways may exist (e.g., between data collector 103 and data processing system manager 102, etc.) without departing from embodiments disclosed herein.

While illustrated in FIG. 1 as including a limited number of specific components, a system in accordance with an embodiment may include fewer, additional, and/or different components than those illustrated therein.

To further clarify embodiments disclosed herein, a diagram illustrating data flows and/or processes performed in a system in accordance with an embodiment is shown in FIG. 2.

FIG. 2 shows a block diagram of a data processing system manager interacting with a data collector and a data processing system in accordance with an embodiment. Data processing system manager 202 may be similar to data processing system manager 102 shown in FIG. 1. Data collector 200 may be similar to data collector 103 shown in FIG. 1 and data processing system 201 may be similar to any of data processing systems 100 shown in FIG. 1.

Data processing system manager 202 may be connected to data collector 200 and data processing system 201 via a communication system (not shown). Communications between data processing system manager 202, data collector 200, and data processing system 201 are illustrated using lines terminating in arrows.

Data processing system 201 may be positioned remote to data collector 200 and data processing system manager 202. In addition, data processing system 201 may have limited (or no) access to an uplink pathway. The uplink pathway may be used to transmit data from data processing system 201 to data processing system manager 202 (and/or other entities) and a downlink pathway may be used to transmit data from data processing system manager 202 (and/or other entities) to data processing system 201.

Therefore, to observe the operation of data processing system 201, data collector 200 may have access to a pathway that is not the uplink pathway and may use the pathway to transmit observational data to data processing system manager 202. The observational data may include any data related to the operation of data processing system 201, the environment in which data processing system 201 operates, and/or any other data.

Data processing system manager 202 may perform operation simulation 206 process using the observational data and digital twin 204. Digital twin 204 may include a data structure with instructions to simulate operation of data processing system 201. Data processing system manager 202 may be able to simulate operation of data processing system 201 under a range of possible environmental conditions and/or other scenarios based on the observational data.

Operational simulation 206 process may include operating digital twin 204 (e.g., using simulated data, etc.) under simulated environmental and operational conditions based on the observational data to obtain simulated events 208. Digital twin 204 may be intended to duplicate operation of data processing system 201 in the environment in which data processing system 201 operates.

Simulated events 208 may include a list of potential future occurrences of events that may impact operation of data processing system 201. Impacting the operation of data processing system 201 may include causing a departure from nominal operation of data processing system 201.

Data processing system manager 202 may perform command selection 210 process using simulated events 208 (e.g., one event, multiple events, etc.) to obtain command 212. Command selection 210 process may include identifying an action that when performed by data processing system 201 may mitigate the impact of a future occurrence of an event of simulated events 208. Command selection 210 process may be performed via a process that data processing system 201 is incapable of performing due to insufficient access to computing resources.

Command 212 may be intended to be performed data processing system 201 prior to the future occurrence of the event and/or concurrently with the future occurrence of the event. Command 212 may include a data structure with instructions for data processing system 201 to implement command 212. The instructions may include a series of actions, a schedule for performing the series of actions, indicators for trigger conditions for performing the series of actions, etc.

Data processing system manager 202 may provide command 212 to data processing system 201 via a downlink pathway of a communication system.

In an embodiment, data processing system manager 202 is implemented using a processor adapted to execute computing code stored on a persistent storage that when executed by the processor performs the functionality of data processing system manager 202 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage operation of data processing systems throughout a distributed environment. FIG. 3 illustrates methods that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system with limited access to an uplink pathway in accordance with an embodiment is shown. The method may be performed, for example, by a data processing system manager, data processing system, and/or any other device.

At operation 300, observational data for an environment in which the data processing system is located is obtained. Obtaining the observational data may include: (i) receiving the observational data in the form of a message over a communication system (e.g., from a data collector positioned remote to the data processing system), (ii) by accessing a database (locally or offsite) where the observational data is stored, (iii) by reading the observational data from storage, and/or other methods. The observational data may be obtained according to a schedule indicating regular transmissions of observational data (e.g., once per hour, once per day, etc.), upon request by an entity for the observational data, in response to an event, and/or by following any other previously determined schedule.

At operation 302, operation of the data processing system is simulated using the observational data and a digital twin.

Simulating the operation of the data processing system may include: (i) obtaining the digital twin of the data processing system, and/or (ii) performing a simulation of operation of the data processing system using the digital twin.

The digital twin may be obtained by: (i) reading the digital twin from storage, (ii) obtaining the digital twin from an entity responsible for generating and/or managing digital twins, (iii) by generating the digital twin (e.g., by obtaining a copy of software executed by the data processing system to perform computer-implemented services), and/or (iv) via other methods. Obtaining the digital twin may also include utilizing the observational data (and/or historical observational data) to establish parameters of the digital twin to simulate operation of the data processing system under certain environmental conditions.

Performing the simulation of the operation of the data processing system may include: (i) obtaining input data for the digital twin, and/or (ii) performing computations using the digital twin and the input data to simulate operation of the data processing system.

The input data may be obtained by: (i) reading the input data from storage, (ii) simulating the input data using an inference model (e.g., a neural network, etc.), (iii) requesting the input data from another entity throughout the distributed environment, and/or (iv) via other methods.

Performing the computations using the digital twin and the input data may include feeding the input data into the digital twin and obtaining a simulated output, the simulated output being intended to match an output generated by the data processing system.

The computations may also be performed by providing the input data to another entity responsible for hosting and operating the digital twin and receiving the simulated output in response from the entity.

Following performing the simulation, characteristics of the simulated operation may be identified, entered into a data structure, and stored in storage for future use.

At operation 304, a future occurrence of an event that is likely to occur and that will impact the operation of the data processing system is identified based on the simulated operation.

Identifying the future occurrence of the event may include: (i) obtaining the characteristics of the simulated operation, (ii) identifying a portion of the simulated operation, based on the characteristics, in which the simulated operation departs from nominal operating conditions.

The characteristics of the simulated operation may be obtained by reading the characteristics of the simulated operation from storage, by requesting the characteristics of the simulated operation from another entity responsible for storing the characteristics of the simulated operation, and/or by generating the characteristics of the simulated operation.

The characteristics may include, for example: (i) raw and/or processed simulated data, (ii) computations performed during the simulated operation, (iii) statistics related to the computations performed during the simulated operation (e.g., rates of computations performed, accuracy of computations performed, etc.), and/or other characteristics.

The portion of the simulated operation may be identified by: (i) generating a data structure including a time series relationship for a characteristic of the simulated operation (e.g., a rate of operation over time, an accuracy of computations over time), (ii) comparing the time series relationship for the characteristic of the simulated operation to a representation of nominal operation of the data processing system (e.g., a time series relationship for a corresponding characteristic of the nominal operation of the data processing system), and/or (iii) identifying a timestamp associated with a portion of the time series relationship for the characteristic of the simulated operation that does not match the representation of the nominal operation within a threshold as the event.

The portion of the simulated operation may also be identified by: (i) requesting another entity identify and provide the portion, (ii) by reading the portion from storage, and/or (iii) other methods.

At operation 306, a command for performance by the data processing system is selected, the command being expected to mitigate an impact of the future occurrence of the event when performed by the data processing system.

Selecting the command for performance by the data processing system may include performing a lookup process using a command lookup table and an identifier of the event as a key for the command lookup table. Performing the lookup process may include inputting the identifier as the key for the command lookup table and obtaining one or more commands as output from the command lookup table.

Selecting the command may also include: (i) re-simulating the operation of the data processing system using the observational data, the digital twin, and the command, and/or (ii) identifying, based on the re-simulated operation, that the future occurrence of the event is unlikely to occur.

Re-simulating the operation of the data processing system may include operating the digital twin as previously described with respect to operation 302 with the addition of the command, the command instructing the digital twin to perform an action set in response to certain conditions being met with the intention of avoiding and/or remediating an impact of the future occurrence of the event.

Identifying that the future occurrence of the event is unlikely to occur may include monitoring characteristics (e.g., the previously mentioned time series relationship and/or other characteristics) of the re-simulated operation and comparing the characteristics of the re-simulated operation to the representation of the nominal operation as previously described.

Identifying that the future occurrence of the event is unlikely to occur may also include failing to identify the event during the comparison of characteristics of the re-simulated operation to the representation of the nominal operation.

At operation 308, the command is provided to the data processing system to initiate performance of the command.

Providing the command to the data processing system may include transmitting the command in the form of a message over a downlink pathway of a communication system. The command may also be provided to the data processing system by adding the command to a database accessible by the data processing system along with instructions for implementing the command, by transmitting the command to another entity responsible for providing the command to the data processing system, and/or via other methods.

Following operation 308, a similar data processing system may be identified. The similar data processing system may be subject to conditions similar to those associated with the data processing system (e.g., similar environmental conditions, similar operational instructions, etc.). To identify the similar data processing system, additional observational data may be obtained (e.g., from the data collector and/or other data collectors) for one or more additional data processing systems. Characteristics associated with the additional observational data may be compared to the characteristics associated with the observational data for the data processing system and any additional data processing system with similar characteristics to the data processing system (e.g., within a threshold, etc.) may be treated as the similar data processing system.

Following identification of the similar data processing system, the command may be provided to the similar data processing system. Providing the command to the similar data processing system may include transmitting the command in the form of a message over a downlink pathway of a communication system. The command may also be provided to the similar data processing system by adding the command to a database accessible by the similar data processing system along with instructions for implementing the command, by transmitting the command to another entity responsible for providing the command to the similar data processing system, and/or via other methods.

By doing so, data processing systems (e.g., the data processing system, the similar data processing system, etc.) that share similar operational characteristics and, therefore, may encounter similar events, may benefit from the use of the command. Rather than generating commands for each data processing system separately, proving the command to a group of similar data processing systems may conserve computing resources and increase efficiency throughout the distributed environment.

The method may end following operation 308.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of a data processing system with limited access to an uplink pathway by a data processing system manager, the method comprising:
obtaining observational data for an environment in which the data processing system is located;
simulating operation of the data processing system using the observational data and a digital twin, the digital twin being intended to duplicate operation of the data processing system in the environment;
identifying, based on the simulated operation, a future occurrence of an event that is likely to occur and that will impact the operation of the data processing system;
selecting a command for performance by the data processing system, the command being expected to mitigate an impact of the future occurrence of the event when performed by the data processing system; and
providing the command to the data processing system to initiate performance of the command.

2. The method of claim 1, wherein the uplink pathway is used to obtain data from the data processing system and a downlink pathway is used to transmit data to the data processing system.

3. The method of claim 2, wherein the observational data is obtained from a data collector, the data collector being located remote to the data processing system and being capable of transmitting the observational data via a different pathway from the uplink pathway.

4. The method of claim 1, wherein impacting the operation of the data processing system comprises causing a departure from nominal operation of the data processing system.

5. The method of claim 1, wherein selecting the command is performed via a process the data processing system does not have sufficient computing resources to perform.

6. The method of claim 5, wherein selecting the command comprises:
re-simulating the operation of the data processing system using the observational data, the digital twin, and the command; and
identifying, based on the re-simulated operation, that the future occurrence of the event is unlikely to occur.

7. The method of claim 6, wherein the command is intended to be performed:
prior to the future occurrence of the event, or
concurrently with the future occurrence of the event.

8. The method of claim 1, further comprising:
identifying a similar data processing system, the similar data processing system being subject to conditions similar to those associated with the data processing system; and
providing the command to the similar data processing system.

9. A non-transitory machine-readable medium having instructions stored therein, which when executed by a processor, cause the processor to perform operations for managing operation of a data processing system with limited access to an uplink pathway by a data processing system manager, the operations comprising:
obtaining observational data for an environment in which the data processing system is located;
simulating operation of the data processing system using the observational data and a digital twin, the digital twin being intended to duplicate operation of the data processing system in the environment;
identifying, based on the simulated operation, a future occurrence of an event that is likely to occur and that will impact the operation of the data processing system;
selecting a command for performance by the data processing system, the command being expected to mitigate an impact of the future occurrence of the event when performed by the data processing system; and
providing the command to the data processing system to initiate performance of the command.

10. The non-transitory machine-readable medium of claim 9, wherein the uplink pathway is used to obtain data from the data processing system and a downlink pathway is used to transmit data to the data processing system.

11. The non-transitory machine-readable medium of claim 10, wherein the observational data is obtained from a data collector, the data collector being located remote to the data processing system and being capable of transmitting the observational data via a different pathway from the uplink pathway.

12. The non-transitory machine-readable medium of claim 9, wherein impacting the operation of the data processing system comprises causing a departure from nominal operation of the data processing system.

13. The non-transitory machine-readable medium of claim 9, wherein selecting the command is performed via a process the data processing system does not have sufficient computing resources to perform.

14. The non-transitory machine-readable medium of claim 13, wherein selecting the command comprises:
re-simulating the operation of the data processing system using the observational data, the digital twin, and the command; and
identifying, based on the re-simulated operation, that the future occurrence of the event is unlikely to occur.

15. A data processing system, comprising:
a processor; and
a memory coupled to the processor to store instructions, which when executed by the processor, cause the processor to perform operations for managing operation of a data processing system with limited access to an uplink pathway by a data processing system manager, the operations comprising:
obtaining observational data for an environment in which the data processing system is located;
simulating operation of the data processing system using the observational data and a digital twin, the digital twin being intended to duplicate operation of the data processing system in the environment;
identifying, based on the simulated operation, a future occurrence of an event that is likely to occur and that will impact the operation of the data processing system;
selecting a command for performance by the data processing system, the command being expected to mitigate an impact of the future occurrence of the event when performed by the data processing system; and
providing the command to the data processing system to initiate performance of the command.

16. The data processing system of claim 15, wherein the uplink pathway is used to obtain data from the data processing system and a downlink pathway is used to transmit data to the data processing system.

17. The data processing system of claim 16, wherein the observational data is obtained from a data collector, the data collector being located remote to the data processing system and being capable of transmitting the observational data via a different pathway from the uplink pathway.

18. The data processing system of claim 15, wherein impacting the operation of the data processing system comprises causing a departure from nominal operation of the data processing system.

19. The data processing system of claim 15, wherein selecting the command is performed via a process the data processing system does not have sufficient computing resources to perform.

20. The data processing system of claim 19, wherein selecting the command comprises:
re-simulating the operation of the data processing system using the observational data, the digital twin, and the command; and
identifying, based on the re-simulated operation, that the future occurrence of the event is unlikely to occur.
